(19) United States
(12) Patent Application Publication
(10) Pub. No.: US 2004/0182469 A1
(43) Pub. Date: Sep. 23, 2004

(54) Apparatus for filling bags with loose material and automatic machine equipped with said apparatus

(75) Inventor: Teodoro Concetti, Bastia Umbra (PG) (IT)

Correspondence Address: THE FIRM OF KARL F ROSS, 5676 RIVERDALE AVENUE, PO BOX 900, RIVERDALE (BRONX), NY, 10471-0900, US

(73) Assignee: CONCETTI S.P.A.

(21) Appl. No.: 10/801,616

(22) Filed: Mar. 16, 2004

(30) Foreign Application Priority Data
Mar. 18, 2003 (IT) MI2003A000519

(51) Int. Cl. B65B 1/04; B65B 43/26; B67C 3/00

(52) U.S. Cl. 141/10; 53/459; 53/502; 53/570; 141/374

(57) ABSTRACT

Apparatus for filling bags (1) with loose material (2), comprising a tube (210) for supplying the material (2), substantially coaxial with the said bag, said tube (210) being able to move from a position with the supply mouth (210a) outside the bag to a position with the supply mouth (210a) inside the bag (1) and arranged at a height substantially coinciding with the bottom (1b) of the bag (1) where filling is started, and vice versa.

### DESCRIPTION

The present invention relates to an apparatus for filling bags with loose material.

It is known in the product sector relating to the packaging of loose material that there exists the need to introduce the said material inside bags which must be filled with a certain defined quantity of material and then sealed.

It is also known that automatic bag filling machines have been designed for this purpose, an example of said machines consisting of so-called forming/filling machines which are able to perform, at high speed, the cycle involving forming of the bag, filling of the bag and final sealing of the mouth thereof.

Said machines, which are known per se, comprise in particular stations for filling the bag with the material contained inside a hopper arranged in a position substantially coaxial with the bag and greater than the height of the bag mouth, said quantity of product for filling being able to be determined substantially using three main techniques referred to as follows:

net weight technique, namely with weighing of the product before it is introduced into the bag;

gross weight technique, namely with weighing of the product together with the bag being filled;

volumetric technique, namely with the provision of a predefined volume of product irrespective of measurement of its overall weight.

Machines of this type, which are known for example from EP 0,595,778 in the name of the present Applicant, comprise a step involving filling of the bag performed by causing the product to fall by means of gravity inside the bag which is filled using the gross weight technique.

Although performing its function, this method of the filling the bag by means of gravity involves certain problems resulting from the fact that the falling movement of the product generates a large amount of dust which tends to spread outside, causing contamination of the surrounding environment; with gravity filling, moreover, a large quantity of air is also introduced into the bag and must be removed so as to allow correct filling with the correct weighed quantity of material.

In addition to this, in the case of products with a high adhesive power, said products tend to adhere both to the walls of the hopper which with time tends to become blocked, preventing correct and fast filling of the bag, and to the internal surface of the bag mouth, resulting in subsequent unreliable sealing of the mouth, usually performed by means of heat-welding.

U.S. Pat. No. 4,074,507 also discloses a bag filling device based on the use of a feeder screw which deposits on the bottom of the bag a predefined volume of product so as to limit the formation of dust and the introduction of air inside the bag.

The apparatus described has however the drawback that it requires raising of the bag in order to bring the bottom thereof to the height of the bottom end of the feeder screw where the product is released.

This results in drawbacks associated with prolonged downtime during the machine cycle, resulting from the need to raise the bag with respect to its feeding height through the machine and move it back down again to the said feeding height, following filling thereof.

In addition to this, filling the bag at a height raised from the ground increases the risk of contamination, both during the operation and in the event of breakage of the bag or escaping of the product which tends to spread over an area which is all the more extensive the higher the said filling height.

The technical problem which is posed, therefore, is that of providing an apparatus for filling bags with loose material, for example dust and/or finely ground flour, which is able to fill the bag with a substantial reduction in the formation of dust and introduction of air into the bag and at a high speed, so as to allow the high hourly production outputs required by modern industry to be maintained.

Within the context of this problem, a further requirement is that the apparatus in question should be easy and inexpensive to manufacture and assemble, able to be installed also in machines of the known type without the need for substantial modification thereof and suitable for filling bags with materials which have a strong tendency to adhere to the walls of the apparatus and the bag and/or with a high quantity of intermolecular air.

According to the present invention, said technical problem is solved by an apparatus for filling bags with lose material, comprising a tube for supplying the material, which is substantially coaxial with the said bag, said tube being able to move from a position with the supply mouth outside the bag, to a position with the supply mouth inside the bag and arranged at a height substantially coinciding with the bottom of the bag, where filling is started, and vice versa.

The present invention also relates to an automatic machine equipped with a filling apparatus as described above and a method for filling a bag using an apparatus as described above.

Further details may be obtained from the following description of a non-limiting example of embodiment of the subject of the present invention, provided with reference to the accompanying drawings, in which:

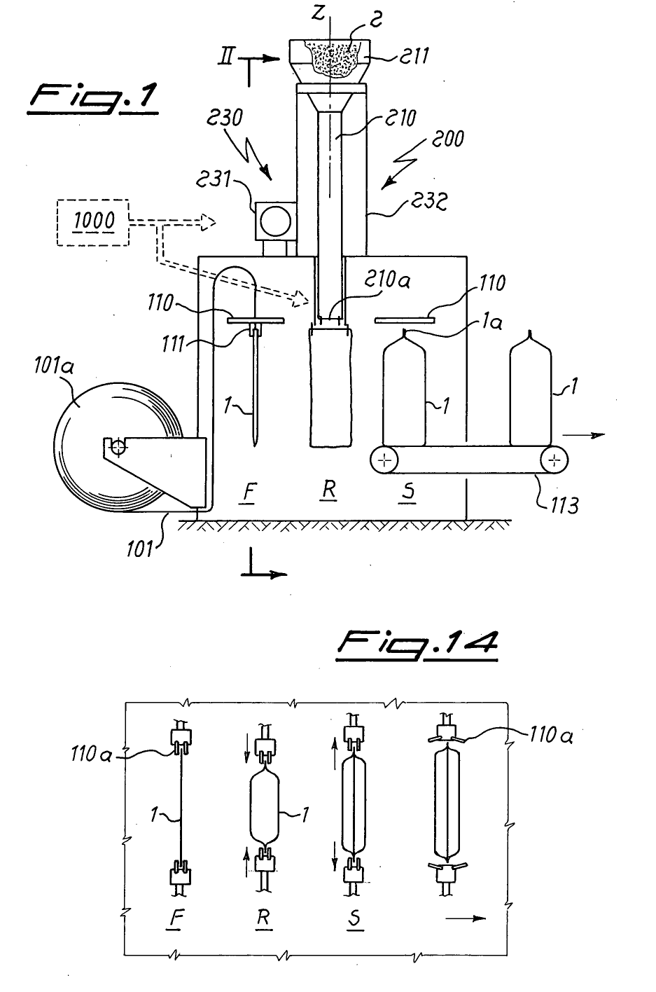

FIG. 1 shows a schematic side view of a forming/filling machine with a filling apparatus according to the invention;

FIG. 2 shows a schematic cross-section along the plane indicated by II-II in FIG. 1 with the apparatus in the rest condition outside the bag;

FIG. 3 shows a schematic cross-section, similar to that of FIG. 2, with the apparatus performing filling of the bag;

FIG. 4 shows a schematic cross-section, similar to that of FIG. 2, with the apparatus moving out of the bag;

FIG. 5 shows a schematic cross-section, similar to that of FIG. 2, of a second example of embodiment of the apparatus according to the present invention with the apparatus in the rest condition outside the bag;

FIG. 6 shows the apparatus according to FIG. 5 during the first bag filling step;

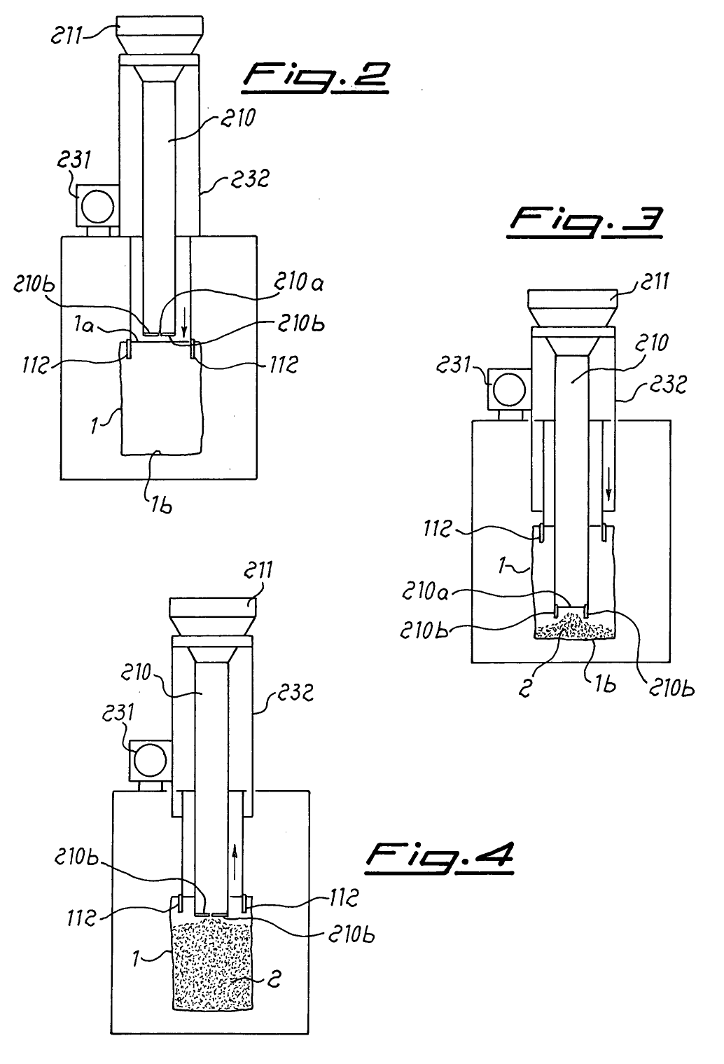

FIG. 7 shows the apparatus according to FIG. 5 at the end/start of the first/second filling step;

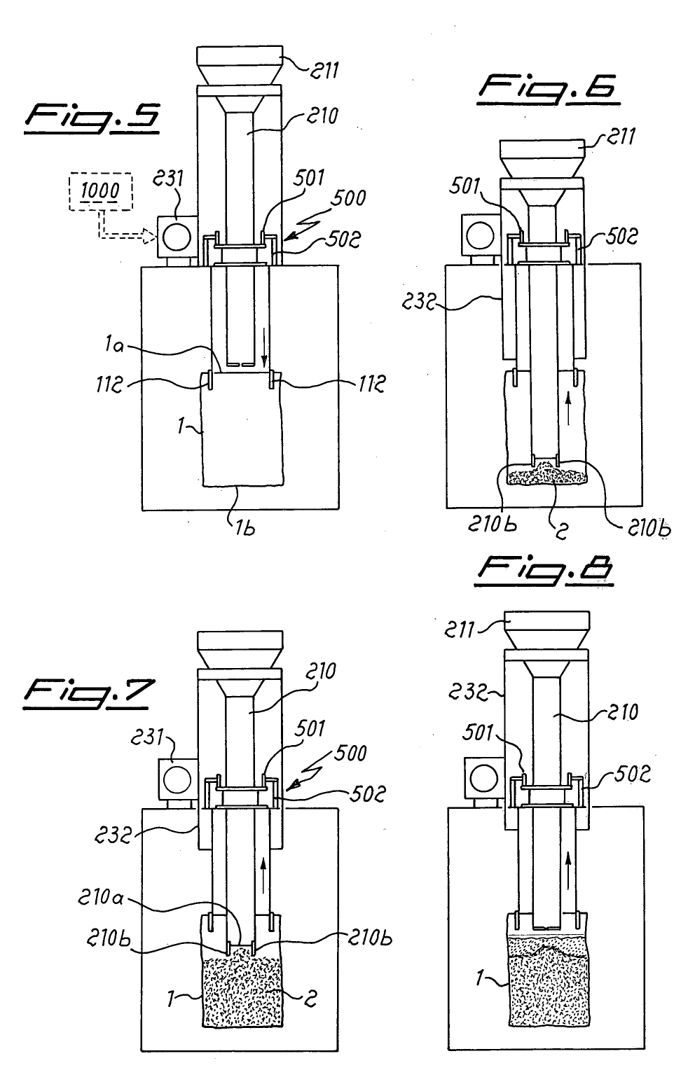

FIG. 8 shows the apparatus according to FIG. 5 at the end of the second filling step;

FIG. 9 shows a cross-section, similar to that of FIG. 2, of a further example of embodiment of the apparatus according to the present invention;

FIG. 10 shows a side view of the apparatus according to the present invention associated with air and dust suction means;

FIG. 11 shows a schematic cross-section along the plane indicated by XI-XI in FIG. 10;

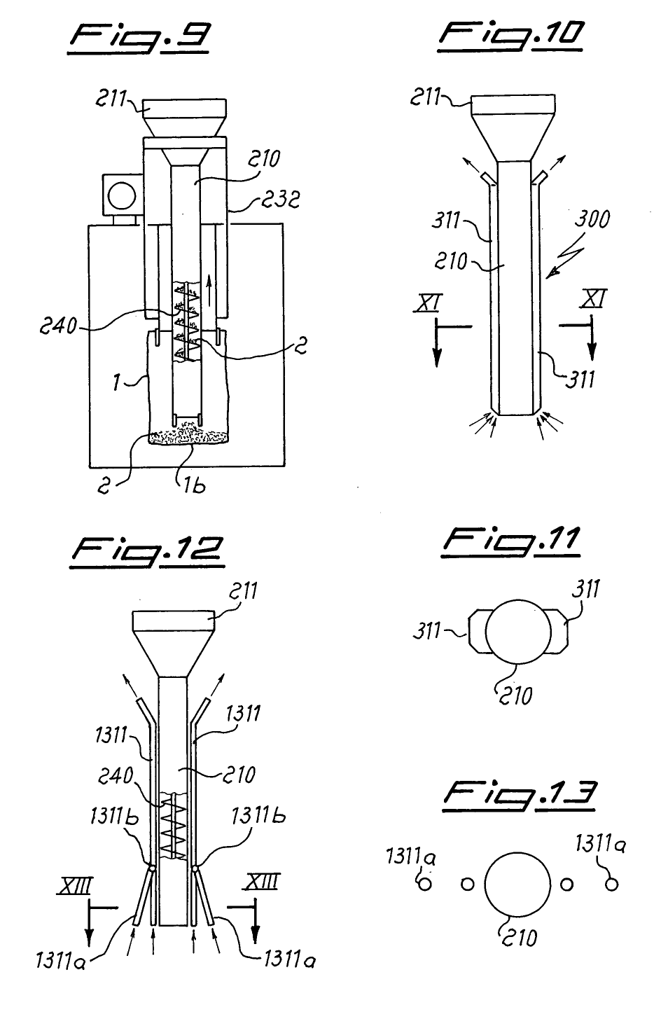

FIG. 12 shows a side view of the apparatus according to the present invention, associated with means for deaerating the product to be bagged;

FIG. 13 shows a cross-section along the plane indicated by XIII-XIII in FIG. 12; and

FIG. 14 shows a schematic view, from above, of the forming/filling machine with a filling apparatus according to the present invention.

As schematically shown in FIG. 1, an illustrative, but non-limiting example of a machine for filling bags 1 with loose material 2 may be of the forming/filling type which essentially comprises at least three work stations, i.e.:

a station F for forming the bag 1 from a tubular material 101 unwound from a reel 101a;

a station R for filling the bag with the material supplied from the filling apparatus 200;

a station S for sealing the mouth 1a of the bag. Conveying of the bag from one station to the other is performed by means of a slide 110 equipped with gripping means 111, while removal of the bag from the machine is performed by means of a motor-driven belt 113.

Pairs of fixed grippers 112 suitably designed to support the weight of the full bag are also arranged in the filling station.

As illustrated in FIG. 14, in a preferred embodiment of the forming/filling machine, the said bag conveying means consist of a slide 110 which can be displaceably actuated with an alternating outward and return movement and is equipped with pairs of facing grippers 110a for gripping the bag along their opposite vertical edges, said slide being able to impart to the grippers 110a movements in a direction transverse to the direction of feeding of the bag such as to cause opening of its mouth during travel from the forming station F to the filling station R and closing thereof during travel from the station R to the sealing station S.

In a preferred embodiment, variations in the height of the mouth 1a of the bag during the rectilinear movement of the slide 110 do not occur.

As illustrated in FIGS. 1 and 2, the filling apparatus according to the invention is essentially composed of a tube 210, the top end of which is integral with a hopper 211 which contains the product 2 for filling the bag which, during processing, will be arranged with its mouth 1a (FIG. 1) in a coaxial position underneath the said tube 210.

The mouth 210a supplying the product 2 is equipped with rotating plates 210b able to be arranged transversely with respect to the mouth 210a of the tube, so as to cause closing thereof, and parallel thereto, so as to cause opening thereof.

The hopper 211 is connected to means 230 for displaceably actuating it in both directions along a vertical axis Z shown in FIG. 1; in a preferred embodiment said means 230 consist of a motor 231 which is fixed to the frame of the machine and connected by means of transmission means, known per se, to a frame 232 integral with the hopper 211.

The apparatus is also associated with means 1000 for programming and controlling the actuating movements and the various working sequences.

With reference to the exemplary, but non-limiting example of embodiment of a forming/filling machine described above, the operating principle of the apparatus is as follows:

following preparation of a quantity of material 2 to be inserted into the bag 1,

the slide 110 (FIG. 2) conveys the bag 1, formed and with the mouth 1a open, to the filling station R in a position substantially coaxial with that of the tube 210 where the bag is gripped by the fixed grippers 112,

the means 1000 for operation and control of filling activate (FIG. 3) the motor 231 so as to move the frame 232 downwards and bring the mouth 210a of the tube 210 to a predefined height in the vicinity of the bottom 1b of the bag 1;

at this point (FIG. 3) the operating and control means 1000 cause rotation of the plates 210b such as to open the mouth 210a of the tube 210, causing the product 2 to come out of the said tube 210;

at the same time, the means 230 for actuating the tube reverse their action, causing a controlled return movement upwards of the tube 210 to a height where the filling step is completed (FIG. 4);

whereupon the mouth 210a of the tube is closed, interrupting the supply;

the return movement upwards of the tube 210 is completed so as to disengage it from the bag which may be conveyed by the conveying means 110 to the following sealing station S.

It is therefore obvious how, with the apparatus according to the invention, it is possible to fill the bag with low formation of dust, reducing among other things the bag sealing defects, and keep the said bag at a fixed conveying height through the various stations of the machine with saving in downtime and high filling efficiency.

According to a preferred embodiment it is envisaged moreover that the means 230 for performing displacement of the apparatus 200 may be of the variable speed type so as to cause introduction/extraction of the tube into/from the bag at high speed and raising of the tube during filling at low speed so as to maintain the abovementioned filling characteristics, reducing the cycle downtime.

In the configuration described it is envisaged moreover that filling of the bag is performed using a method known as the net weight/volumetric type or with weighing/preparation of a volume of product upstream of its introduction into the bag since these methods allow higher production outputs to be maintained.

As illustrated in FIG. 9, a variation of embodiment of the apparatus is envisaged, said variation comprising a feeder screw 240 coaxially arranged inside the tube 210. Said feeder screw conveys measured quantities of product 2 from the hopper 211 to the bottom 1b of the bag, performing in this case a further product filling method of the volumetric type, which is particularly suitable for products with a high intermolecular air content and/or high adhesive power. In a further embodiment illustrated in FIGS. 5 to 8, the apparatus according to the invention also comprises bag weighing devices 500 preferably consisting of load sensors 501 integral with support means 502 and connected to the fixed grippers 112 for retaining the bag during filling.

These devices allow filling of the bag by gross weight. In this configuration mixed operation of the apparatus is also envisaged, as follows:

once the slide 110 has brought the bag 1 into a position substantially coaxial with that of the tube 210 (FIG. 5) and the bag has been gripped by the fixed grippers 112,

the filling operating and control means 1000 activate the motor 231 (FIG. 6) so as to cause the frame 232 to move downwards and bring the mouth 210a of the tube 210 to a predefined height in the vicinity of the bottom 1b of the bag 1;

at this point (FIG. 7) the operating and control means 1000 cause rotation of the plates 210b so as to open the mouth 210a of the tube 210, causing the product 2 to come out of the tube 210;

at the same time (FIG. 7), the tube actuating means 230 reverse their action, causing a controlled return movement upwards of the tube 210 to a predefined height where the first filling step is completed;

once the first filling step has been completed, the operating and control means 1000 enable the weighing devices 500 which from this moment control directly the second bag filling step which is continued (FIG. 8) until the programmed gross weight is reached;

once said gross weight has been reached, the weighing means 500 send a corresponding signal to the control means which close the mouth 210a of the tube, interrupting the supply and completing the return movement upwards of the tube 210 so as to disengage it from the bag which may be transported by the conveying means 110 to the following sealing station S.

In the configuration and with the operating mode described above, the apparatus according to the invention therefore allows filling of the bag with gradual expulsion of the air introduced and at a high speed resulting from the first filling step of the volumetric type and with a high degree of final precision resulting from completion of filling performed under control of the weighing means using the gross weight technique.

In the case where a feeder screw is used to supply the product, the speed of rotation of the feeder screw 240 will be much greater during the first volumetric filling step, compared to its speed of rotation during the second gross weight filling step so as to obtain the desired filling precision.

According to further embodiments, shown in FIGS. 10 and 11, it is envisaged moreover that the filling apparatus according to the invention may be associated with air and dust suction means 300, essentially consisting of longitudinal ducts 311 arranged in a diametral position with respect to the tube 210 and extending substantially over the whole axial length of the tube so as to suck in dust and air from the bottom of the bag and convey them outside of the bag during filling.

In a further embodiment (FIGS. 12, 13), the apparatus is associated with means for deaerating the product, consisting of a plurality of pipes 1311, the bottom end part 1311a of which is hinged with pins 1311b so as to be able to expand in the transverse direction by an amount corresponding to the width of the bag, allowing an increase in the useful suction area.

The present invention also relates to a method for filling bags 1 with loose material 2, which comprises the following steps:

preparing an apparatus 200 for filling bags 1 with loose products 2;

preparing a programmed quantity of material 2 to be inserted into the bag;

conveying a bag 1 into a position substantially coaxial with and underneath the filling apparatus 200;

opening the bag 1 and retaining the bag in said coaxial position and at a fixed height;

introduction of the apparatus 200 inside the bag 1 as far as a predefined height in the vicinity of the bottom 1b thereof;

start of the bag filling step;

simultaneous return movement upwards of the apparatus 200 towards the mouth 1a of the bag 1;

completion of the filling step;

extraction of the filling apparatus from the bag 1.

Once the filling step has been completed, an industrial production cycle will envisage a final bag sealing step.

According to preferred embodiments it is envisaged that:

conveying of the bag 1 is performed at a fixed height;

the speed of introduction/extraction of the filling apparatus 200 into/from the bag is different from the speed of its upward return movement simultaneous with the filling step;

filling is performed by means of gravity using the net weight or gross weight technique or

filling is of the volumetric type;

in the case of volumetric filling, said operation is performed using feeder screw means arranged coaxially inside the filling apparatus;

a dust and air suction step is performed during the bag filling step and/or deaeration of the product;

conveying of the bag 1 underneath the filling apparatus is performed by means of a slide 110 forming part of an automatic machine, preferably of the forming/filling type; said slide 110 is displaceably actuated with an alternating outward and return movement and is equipped with facing pairs of grippers 110a for gripping the bag along its opposite vertical edges, said slide being able to impart to said grippers 110a movements in the direction transverse to the direction of feeding of the bag so as to cause opening of its mouth during travel from the forming station F to the filling station F, and closing of the bag during travel from the station R to the sealing station S.

According to a further embodiment of the method according to the present invention it is envisaged that it is performed in accordance with the following steps:

preparation of an apparatus 200 for filling bags 1 with loose products;

conveying of a bag 1 into a position substantially coaxial with and underneath the filling apparatus 200;

opening of the bag 1 and retaining thereof in said coaxial position at a fixed height;

introduction of the apparatus 200 inside the bag 1 as far as a predefined height in the vicinity of the bottom 1b thereof;

start of a first bag filling step of the volumetric type;

simultaneous return movement upwards of the apparatus 200 towards the mouth 1a of the bag 1;

termination of the said first volumetric filing step;

start of a second filling step using the gross weight technique until the final programmed weight of the bag is reached;

extraction of the filling apparatus from the bag 1.

In a preferred embodiment of the method, the speed of the feeder screw during the first filling step will be kept much higher than the speed of rotation of the feeder screw during the second filling step.

With the variation of the method described above, filling of the bag is performed with gradual expulsion of the air introduced and at a high speed resulting from the first filling step of the volumetric/net weight type and also with a high degree of final precision resulting from completion of filling performed under control of the weighing means using the gross weight technique.

1. Apparatus for filling bags (1) with loose material (2), comprising a tube (210) for supplying the material (2), substantially coaxial with the said bag (1), characterized in that said tube (210) is able to move from a position with the supply mouth (210a) outside the bag to a position with the supply mouth (210a) inside the bag (1) and arranged at a height substantially coinciding with the bottom (1b) of the bag (1) where filling is started, and vice versa.

2. Apparatus according to claim 1, characterized in that it comprises means (112) for retaining the bag (1) at a fixed height.

3. Apparatus according to claim 1, characterized in that the top end of the tube (210) is integral with a hopper (211) containing the product (2).

4. Apparatus according to claim 1, characterized in that it comprises means for displaceably actuating it in both directions along a vertical axis (Z).

5. Apparatus according to claim 4, characterized in that said actuating means (200) consist of a motor (231) connected, by means of transmission means, to a frame (232) integral with the hopper (211).

6. Apparatus according to claim 5, characterized in that said means (230) for displaceably actuating the frame (232) are of the variable/controllable speed type.

7. Apparatus according to claim 1, characterized in that it comprises means for weighing the product (2).

8. Apparatus according to claim 7, characterized in that said means for weighing the product (2) are arranged upstream of the said supply tube (210).

9. Apparatus according to claim 1, characterized in that it comprises means (500) for weighing the bag (1) during filling.

10. Apparatus according to claim 9, characterized in that said weighing means (500) consist of load sensors (501) connected to the bag retaining means (112).

11. Apparatus according to claim 1, characterized in that the mouth (210a) supplying the product (2) is equipped with rotating plates (210b) able to be arranged transversely with respect to the mouth (210a) of the tube, so as to cause closing thereof, and, parallel thereto, so as to cause opening thereof.

12. Apparatus according to claim 1, characterized in that it comprises means (240) for measuring the volume of the product (2) to be introduced into the bag (1).

13. Apparatus according to claim 12, characterized in that said volume measuring means consist of a feeder screw (240) coaxially arranged inside the tube (210) and able to convey measured quantities of product (2) from the hopper (211) to the bottom (1b) of the bag.

14. Apparatus according to claim 13, characterized in that said feeder screw (240) is associated with variable speed actuating means with a system for control thereof.

15. Apparatus according to claim 1, characterized in that it is associated with air and dust suction means (300).

16. Apparatus according to claim 15, characterized in that said suction means consist of longitudinal ducts (310) arranged in a diametral position with respect to the tube (210) and extending substantially along the whole axial length of the said tube.

17. Apparatus according to claim 1, characterized in that it comprises deaeration means consisting of a plurality of pipes (1311), the bottom end part (1311a) of which is hinged with pins (1311b) able to allow expansion thereof in the transverse direction, by an amount corresponding to the width of the bag.

18. Machine for filling bags (1) with loose material (2), comprising at least one filling station (R) where there is a filling apparatus (200) comprising a tube (210) for supplying the material, substantially coaxial with the said bag (1), characterized in that said tube (210) is able to move from a rest position with the supply mouth (210a) outside the bag (1) to a position with the supply mouth (210a) inside the bag and at a height substantially corresponding to that of the bottom (1b) of the bag (1) where filling is started, and vice versa.

19. Machine according to claim 18, characterized in that it comprises means (112) for retaining the bag (1) at a fixed height.

20. Machine according to claim 18, characterized in that the top end of the tube (210) is integral with a hopper (211) containing the product (2).

21. Machine according to claim 18, characterized in that it comprises means (230) for displaceably actuating the filling apparatus in both directions along a vertical axis (Z).

22. Machine according to claim 21, characterized in that said means (230) for displaceably actuating the filling apparatus consist of a motor (231) connected, by means of transmission means, to a frame (232) integral with the hopper (211).

23. Machine according to claim 21, characterized in that said means (230) for actuating the frame (232) are of the variable/controllable speed type.

24. Machine according to claim 18, characterized in that it comprises means for weighing the product (2).

25. Machine according to claim 24, characterized in that said means for weighing the product (2) are arranged upstream of the said supply tube (210).

26. Machine according to claim 18, characterized in that it comprises means (500) for weighing the bag (1) during filling.

27. Machine according to claim 26, characterized in that said weighing means (500) consist of load sensors (501) connected to the bag retaining means (112).

28. Machine according to claim 24, characterized in that the mouth (210a) of the tube (210) supplying the product (2) is equipped with rotating plates (210b) able to be arranged transversely with respect to the mouth (210a) of the tube, so as to cause closing thereof, and parallel thereto, so as to cause opening thereof.

29. Machine according to claim 18, characterized in that it comprises means (240) for measuring the volume of the product (2) to be introduced into the bag (1).

30. Machine according to claim 29, characterized in that said volume measuring means consist of a feeder screw (240) coaxially arranged inside the supply tube (210) and able to convey measured quantities of product (2) from the hopper (211) to the bottom (1b) of the bag.

31. Machine according to claim 30, characterized in that said feeder screw (240) is associated with variable speed actuating means with a system for control thereof.

32. Machine according to claim 18, characterized in that it is associated with air and dust suction means (300).

33. Machine according to claim 32, characterized in that said suction means consist of longitudinal ducts (310) arranged in a diametral position with respect to the supply tube (210) and extending substantially over the whole axial length of the said tube.

34. Machine according to claim 18, characterized in that it comprises deaeration means consisting of a plurality of pipes (1311), the bottom end part (1311a) of which is hinged with pins (1311b) able to allow expansion thereof in the transverse direction, by an amount corresponding to the width of the bag.

35. Machine according to claim 18, characterized in that it is a forming/filling machine.

36. Machine according to claim 35, characterized in that it comprises at least one station (F) for forming the bag (1) from a tubular material (101) unwound from a reel (101a), at least one station (R) for filling the bag with the material supplied by the filling apparatus (200), and at least one station (S) for sealing the mouth (1a) of the bag.

37. Machine according to claim 35, characterized in that it comprises means (110) for conveying the bag from the forming station (F) to the filling station (R) and to the sealing station (S).

38. Machine according to claim 37, characterized in that said conveying means consist of a slide (110) displaceably actuated with an alternating outward and return movement and equipped with facing pairs of grippers (110a) for gripping the bag along the opposite vertical edges thereof.

39. Machine according to claim 38, characterized in that said slide is able to impart to the grippers (110a) movements in the direction transverse to the direction of feeding of the bag (1) so as to cause opening of its mouth (1a) during travel from the forming station (F) to the filling station (R) and closing thereof during travel from the station (R) to the sealing station (S).

40. Machine according to claim 38, characterized in that the displacement movements of said slide (110) are at a fixed height.

41. Method for filling a bag (1) with loose material (2), characterized in that it comprises the following steps:
preparation of an apparatus (200) for filling bags (1) with loose products (2);
preparation of a programmed quantity of material (2) to be introduced into the bag;
conveying of a bag (1) into a position substantially coaxial with and underneath the filling apparatus (200);
opening of the bag (1) and retaining thereof in said coaxial position and at a fixed height;
introduction of the apparatus (200) inside the bag (1) as far as a predefined height in the vicinity of the bottom (1b) thereof;
start of the first bag filling step;
simultaneous return movement upwards of the apparatus ('200) towards the mouth (1a) of the bag (1);
termination of the filling step at a predefined height inside the bag (1);
extraction of the filling apparatus from the bag (1).

42. Method according to claim 41, characterized in that conveying of the bag (1) is performed at a fixed height.

43. Method according to claim 41, characterized in that the speed of introduction/extraction of the filling apparatus (200) into/from the bag is different from the speed of its return upward movement simultaneous with the filling step.

44. Method according to claim 41, characterized in that filling is performed by means of gravity.

45. Method according to claim 41, characterized in that the quantity of product (2) to be inserted into the bag is prepared using a net weight technique.

46. Method according to claim 41, characterized in that the quantity of product (2) to be inserted into the bag is prepared using a gross weight technique.

47. Method according to claim 41, characterized in that filling is of the volumetric type.

48. Method according to claim 47, characterized in that filling is performed using feeder screw means (240) coaxially arranged inside the filling apparatus (200).

49. Method according to claim 41, characterized in that the filling operation comprises the following steps:
start of a first bag filling step of the volumetric type;
simultaneous return movement upwards of the apparatus (200) towards the mouth (1a) of the bag (1);
termination of the said first volumetric filing step;
start of a second filling step using the gross weight technique until the final programmed weight of the bag is reached;
extraction of the filling apparatus from the bag (1).

50. Method according to claim 49, characterized in that the speed of supply of the product (2) during the first filling step is much greater than the supply speed during the second filling step.

51. Method according to claim 49, characterized in that the first volumetric filling step is performed using feeder screw means.

52. Method according to claim 41, characterized in that it comprises dust and air suction during the bag filling step.

53. Method according to claim 41, characterized in that conveying of the bag (1) underneath the filling apparatus (200) is performed by means of conveying means forming part of an automatic machine.

54. Method according to claim 53, characterized in that said conveying means consist of a slide (110).

55. Method according to claim 54, characterized in that said slide (110) is displaceably actuated with an alternating outward and return movement and is equipped with pairs of facing grippers (110a) for gripping the bag along its opposite vertical edges.

56. Method according to claim 54, characterized in that said slide (110) is able to impart movements in a direction transverse to the direction of feeding of the bag (1), so as to cause opening of its mouth (1a) during travel from the forming station (F) to the filling station (R) and closing thereof during travel from the station (R) to the sealing station (S).

57. Method according to claim 53, characterized in that said automatic machine is a forming/filling machine.
